(19) United States
(12) Patent Application Publication
(10) Pub. No.: US 2017/0087995 A1
(43) Pub. Date: Mar. 30, 2017

(54) STRADDLE-TYPE ELECTRIC VEHICLE

(71) Applicant: YAMAHA HATSUDOKI KABUSHIKI KAISHA, Iwata-shi (JP)

(72) Inventors: Jin ITO, Shizuoka (JP); Tsukasa SHIMIZU, Shizuoka (JP); Yuuichi YONEDA, Shizuoka (JP); Asaki FUJIWARA, Shizuoka (JP)

(21) Appl. No.: 15/272,547

(22) Filed: Sep. 22, 2016

(30) Foreign Application Priority Data
Sep. 28, 2015 (JP) 2015-190153

(51) Int. Cl. B60L 11/14; B62M 9/06; B60L 11/18

(52) U.S. Cl. CPC B60L 11/14; B60L 11/1877; B62M 9/06; B60L 2220/52; B62M 2701/0092; B62M 2701/0084

(57) ABSTRACT

A vehicle includes an electric motor and a clutch disposed on a drive shaft. The electric motor is disposed on one side from a middle of the vehicle in the vehicle width direction, while the clutch and a sprocket are disposed on a second side from the middle of the vehicle in the vehicle width direction. The clutch is connected to a clutch lever so that the state of engagement of the clutch is changed in response to an operation of the clutch lever. It is thus possible to increase the degree of freedom in torque transmission control by a driver, to increase an output torque of the electric motor, and to reduce the size of the clutch.

### CROSS-REFERENCE TO RELATED APPLICATION

The present application claims priority to Japanese application JP 2015-190153 filed on Sep. 28, 2015, the entire contents of which are hereby incorporated by reference into this application.

### BACKGROUND OF THE INVENTION

1. Field of the Invention

The present invention relates to a straddle-type electric vehicle that is driven using an electric motor.

2. Description of the Related Art

WO 2011/080790 and Japanese Patent Laid-open Publication No. 2014-234131 disclose an electric motorcycle that utilizes an electric motor as a driving source. In the vehicle disclosed in WO 2011/080790, a torque of the electric motor is transmitted to an output shaft through a clutch and a gear shift mechanism. The output shaft includes a sprocket mounted thereon and is linked to the axle of a driving wheel via a chain. In FIG. 5 of WO 2011/080790, a clutch is disposed on the right side of the vehicle body. The electric motor and the sprocket are disposed on the left side of the vehicle body, and the sprocket is positioned behind the electric motor.

In the vehicle disclosed in Japanese Patent Laid-open Publication No. 2014-234131, a torque of the electric motor is transmitted to an output shaft through a clutch. In FIG. 3 of Japanese Patent Laid-open Publication No. 2014-234131, the electric motor is disposed on the right side of the vehicle body. The clutch and a sprocket mounted on the output shaft are disposed on the left side of the vehicle body. The sprocket is positioned behind the clutch.

In order to increase the torque outputted from the electric motor, it is effective to increase the diameter of the electric motor. However, in a structure disclosed in WO 2011/080790, in which the electric motor and the sprocket are both disposed on the left side of the vehicle body, it is difficult to use an electric motor having a larger diameter because such an electric motor causes interference between the electric motor and the sprocket. Regarding this point, in a structure according to Japanese Patent Laid-open Publication No. 2014-234131, in which an electric motor is disposed on the opposite side from the sprocket, an electric motor having a large diameter may be used without interference between the electric motor and the sprocket.

However, in Japanese Patent Laid-open Publication No. 2014-234131, in which a centrifugal clutch is used as a clutch, the state of engagement of the centrifugal clutch is automatically changed depending on the rotation speed of the electric motor irrespective of an operation by a driver. Accordingly, a driver is required to adjust the torque transmitted to the driving wheel mainly through an acceleration operation and is not able to adjust the torque through a clutch operation. Therefore, it is difficult for a driver to achieve an operation of, for example, instantly disconnecting torque transmission to the driving wheel with his/her own intention.

According to WO 2011/080790, an intermediate shaft is disposed between the drive shaft having the electric motor mounted thereon and the output shaft having the sprocket mounted thereon, and the clutch is disposed on the intermediate shaft. A torque of the electric motor is increased by a speed reduction mechanism including a reduction gear on the driving shaft and a reduction gear that rotates integrally with the clutch before being inputted to the clutch. In this structure, since a large torque is transmitted by the clutch, it is necessary to use a clutch having a large diameter.

### SUMMARY OF THE INVENTION

Preferred embodiments of the present invention provide a straddle-type electric vehicle that increases the degree of freedom in torque transmission control by a driver, increases an output torque of an electric motor, and reduces the size of a clutch.

A straddle-type electric vehicle according to a preferred embodiment of the present invention includes a clutch operator that is operated by a driver; a drive shaft; an electric motor mounted on the drive shaft on a first side of a middle of the vehicle in a vehicle width direction; a clutch mounted on the drive shaft on a second side, opposite to the first side, of the middle of the vehicle in the vehicle width direction, the clutch operator being connected to the clutch to change a state of engagement of the clutch through an operation of the clutch operator by the driver; a first gear mounted on the drive shaft and that receives a torque of the electric motor through the clutch; an output shaft that receives the torque of the electric motor through the first gear on the drive shaft; and an output member mounted on the output shaft on the second side from the middle of the vehicle in the vehicle width direction, and linked to a driving wheel of the vehicle through a torque transmission.

In the above straddle-type electric vehicle, the state of engagement of the clutch is changed through an operation of the clutch operator. Thus, it is possible to increase the degree of freedom in torque transmission control by a driver. Further, the electric motor is disposed on the first side of the middle of the vehicle in the vehicle width direction, while the clutch and the output member are disposed on the second side of the middle of the vehicle in the vehicle width direction. Accordingly, even when an electric motor having a large diameter is used, interference is not caused between the electric motor and the output member. This makes it possible to use an electric motor having a large output torque. Further, in the above described straddle-type electric vehicle, the electric motor and the clutch are both mounted on the drive shaft. Therefore, a smaller torque is transmitted by the clutch, compared to a structure in which, for example, a torque of an electric motor is inputted to a clutch via a speed reduction mechanism. As a result, it is possible to reduce the size of the clutch.

In the straddle-type electric vehicle according to a preferred embodiment of the present invention, a diameter of a motor housing that houses the electric motor is preferably larger than a diameter of a clutch cover that houses the clutch.

In the straddle-type electric vehicle according to a preferred embodiment of the present invention, an intermediate shaft that defines a speed reduction mechanism is preferably disposed between the drive shaft and the output shaft.

In the straddle-type electric vehicle according to a preferred embodiment of the present invention, the intermediate shaft is preferably supported by at least two bearings, and the at least two bearings are preferably located between the electric motor and the clutch in the vehicle width direction. With the above configuration, it is possible to shorten the distance between the intermediate shaft and the drive shaft, and it is thus possible to reduce the size of the driving unit.

In the straddle-type electric vehicle according to a preferred embodiment of the present invention, at least a portion of the two bearings preferably overlap with both of the electric motor and the clutch in a side view of the vehicle body. With the above configuration, the distance between the intermediate shaft and the drive shaft is short, and it is thus possible to reduce the size of the driving unit.

In the straddle-type electric vehicle according to a preferred embodiment of the present invention, the intermediate shaft preferably includes a second gear that is directly or indirectly engaged with the first gear on the drive shaft, and a third gear that has a diameter smaller than a diameter of the second gear and is directly or indirectly engaged with a gear on the output shaft, the intermediate shaft is preferably supported by two bearings, and the second gear and the third gear on the intermediate shaft are preferably located between the two bearings. With the above configuration, a sufficient distance between the two bearings that support the intermediate shaft is secured. Therefore, it is easier to support the two bearings by two half case sections that are combined with each other in the vehicle width direction to define the cases of the driving units.

In the straddle-type electric vehicle according to a preferred embodiment of the present invention, at least a portion of the output member preferably overlaps with a motor housing that houses the electric motor in a side view of the vehicle body.
A straddle-type electric vehicle according to a preferred embodiment of the present invention preferably further includes a motor driver including an inverter and that supplies electric power to the electric motor. The motor driver is preferably disposed forward of the electric motor and the clutch, and preferably overlaps with at least a portion of the electric motor and at least a portion of the clutch in a front view of the vehicle body. With the above configuration, the distance between the electric motor and the motor driver is short, and it is thus possible to shorten a wiring that connects these components. Further, since the motor driver receives more wind while the vehicle is running, it is possible to effectively cool the motor driver.

A straddle-type electric vehicle according to a preferred embodiment of the present invention preferably further includes a battery that stores electric power to be supplied to the electric motor, and a battery case that houses the battery. The drive shaft, the electric motor, the clutch, the output shaft, and the motor driver are preferably disposed below the battery case. The motor driver is preferably located farther rearward than a front end of the battery case, and the output shaft is preferably located farther forward than a rear end of the battery case. With the above configuration, it is possible to prevent the driving unit from becoming large in size in the front-back direction.

A straddle-type electric vehicle according to a preferred embodiment of the present invention preferably further includes a battery that stores electric power to be supplied to the electric motor, and a battery case that houses the battery. The drive shaft, the electric motor, the clutch, and the output shaft are preferably disposed below the battery case. The drive shaft, the electric motor, the clutch, and the output shaft are preferably disposed in the driving unit case, and a width of the battery case is preferably smaller than a width of the driving unit case at a location of the drive shaft. With the above configuration, when a driver straddles the vehicle body, the battery case is readily positioned between his/her both legs.

A straddle-type electric vehicle according to a preferred embodiment of the present invention preferably further includes a motor driver including an inverter and that supplies electric power to the electric motor. The drive shaft, the electric motor, the clutch, the output shaft, and the motor driver are preferably disposed in a driving unit case. The driving unit case preferably includes a first housing space in which the clutch and the output shaft are disposed and a second housing space in which the electric motor and the motor driver are disposed, and the first housing space and the second housing space are preferably defined by a wall in the driving unit case. With the above configuration, since the motor driver is housed in the driving unit case, it is possible to shorten the wiring between the motor driver and the electric motor. Further, since the first housing space and the second housing space are provided, it is possible to supply oil to a device disposed in the first housing space and also to prevent the oil from touching the electric motor and the motor driver disposed in the second housing space.

In a straddle-type electric vehicle according to a preferred embodiment of the present invention, the second housing space preferably includes a motor housing space in which the electric motor is disposed and a driver housing space in which the motor driver is disposed, and the driving unit case preferably includes an opening on a portion thereof to communicate the driver housing space with the motor housing space. With the above configuration, it is possible to electrically connect the electric motor and the motor driver through the opening on the driving unit case.

In a straddle-type electric vehicle according to a preferred embodiment of the present invention, the drive shaft, the electric motor, the clutch, and the output shaft are preferably disposed in a driving unit case. The driving unit case preferably includes a case main body and a motor housing including a motor housing space to house the electric motor, and the motor housing is preferably fixed to the case main body. With the above configuration, it is possible to reduce the width of the driving unit case in the vehicle width direction, compared to a structure in which, for example, another member is disposed between the motor housing and the case main body.

In a straddle-type electric vehicle according to a preferred embodiment of the present invention, the clutch preferably includes a plurality of first clutch plates that rotate integrally with the drive shaft, a plurality of second clutch plates that are alternately arranged with the plurality of first clutch plates and rotate integrally with the first gear on the drive shaft, and a pressure plate that is movable in a shaft direction of the drive shaft in response to an operation of the clutch operator by a driver, and that presses the plurality of first clutch plates and the plurality of second clutch plates toward each other.

In a straddle-type electric vehicle according to a preferred embodiment of the present invention, at least one of the first gear on the drive shaft and the clutch preferably includes an engagement that projects in a shaft direction of the drive shaft and is engaged with the other of the first gear and the clutch. With the above configuration, it is possible to decrease the diameter of the first gear, compared to a structure in which, for example, the first gear and the clutch are engaged with each other using a spline or a projection projecting in the radial direction of the drive shaft. As a result, it is possible to ensure a sufficient reduction ratio while shortening the distance between the drive shaft to the output shaft, that is, while reducing the size of the driving unit.

In a straddle-type electric vehicle according to a preferred embodiment of the present invention, the drive shaft preferably includes a fan mounted thereon to cool the electric motor. With the above configuration, it is possible to improve the cooling capability of the electric motor.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view of an electric motorcycle which is one example of a straddle-type electric vehicle.

FIG. 2 is a side view showing a battery case and a driving unit case.

FIG. 3 is a front view showing a battery case and a driving unit case.

FIG. 4 is a perspective view of a driving unit case.

FIG. 5 is a perspective view of a driving unit case with an electric motor removed from the driving unit case.

FIG. 6 is a side view of a driving unit case.

FIG. 7 is a cross sectional view along the line VII-VII in FIG. 6.

FIG. 8 is a cross sectional view along the line VIII-VIII in FIG. 6.

FIG. 9 is a cross sectional view along the line IX-IX in FIG. 6.

FIG. 10 is a perspective view showing a clutch and a first gear.

### DETAILED DESCRIPTION OF THE PREFERRED EMBODIMENTS

In the following, straddle-type electric vehicles according to preferred embodiments of the present invention will be described. In this specification, an electric motorcycle 1 will be described as one non-limiting example of a straddle-type electric vehicle. The present invention may be applied to, for example, a straddle-type automobile or a straddle-type tricycle.

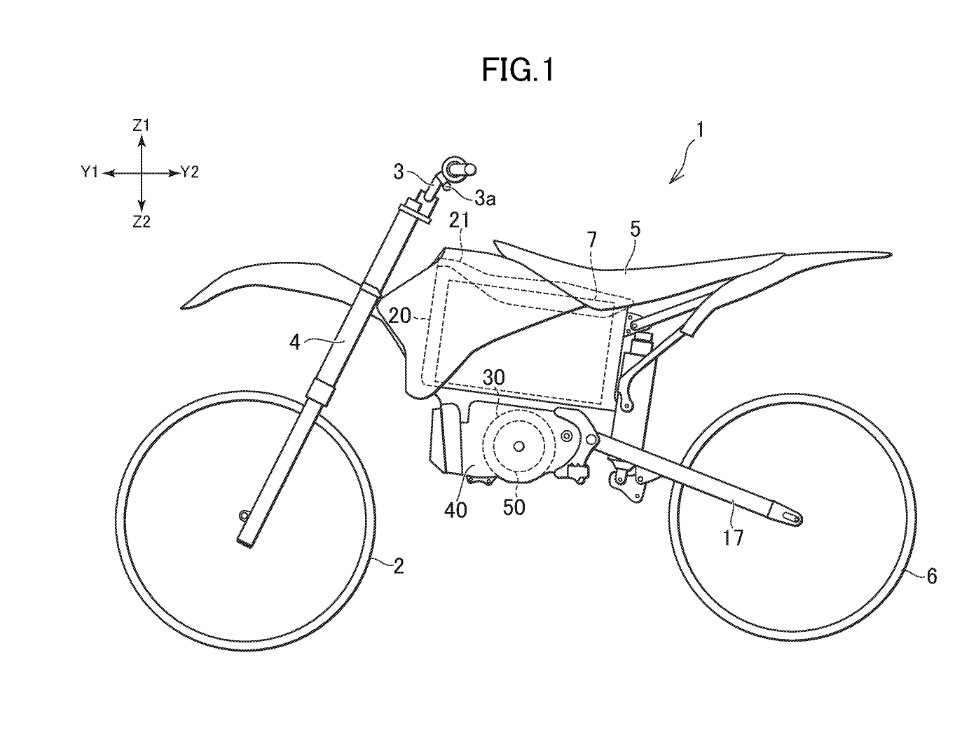

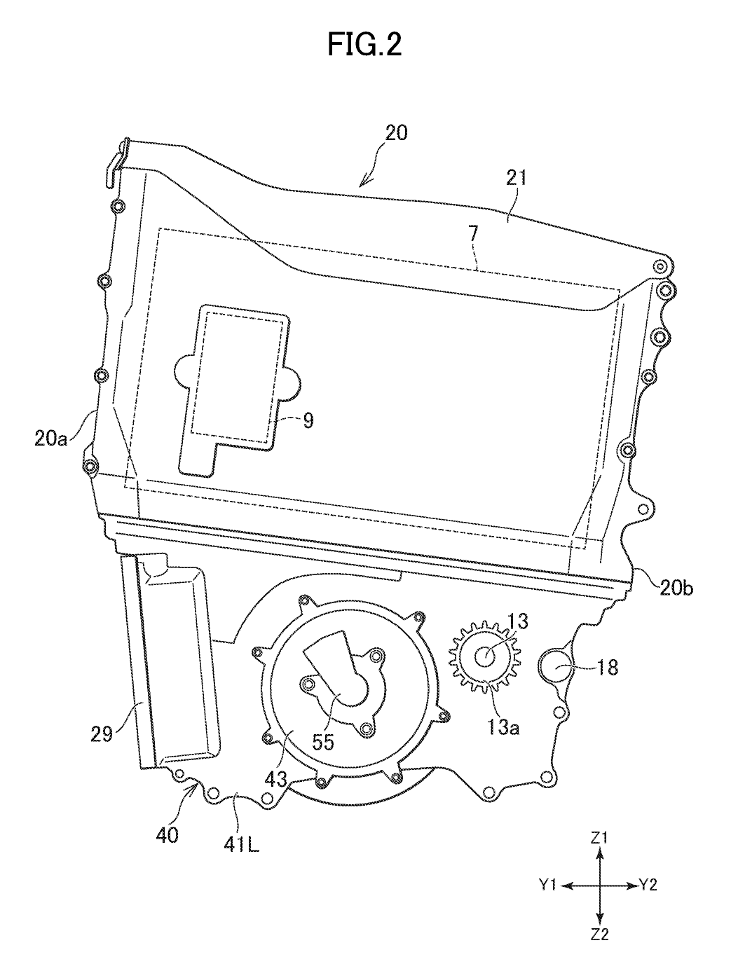

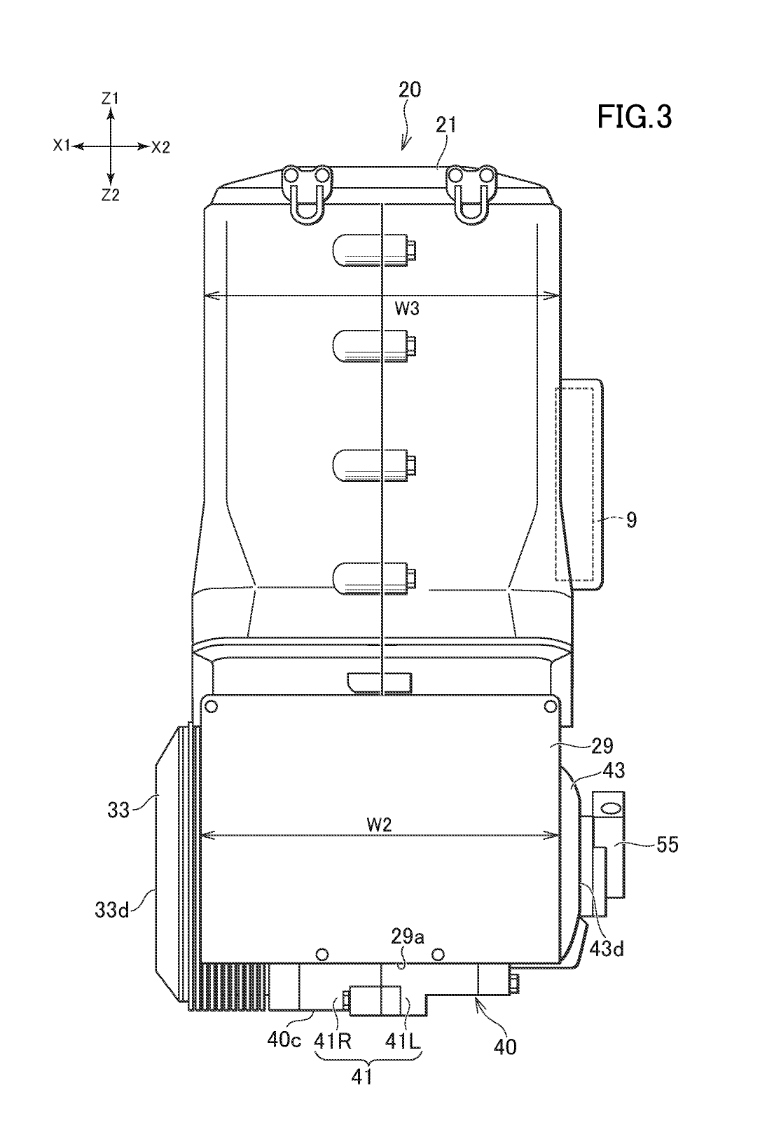

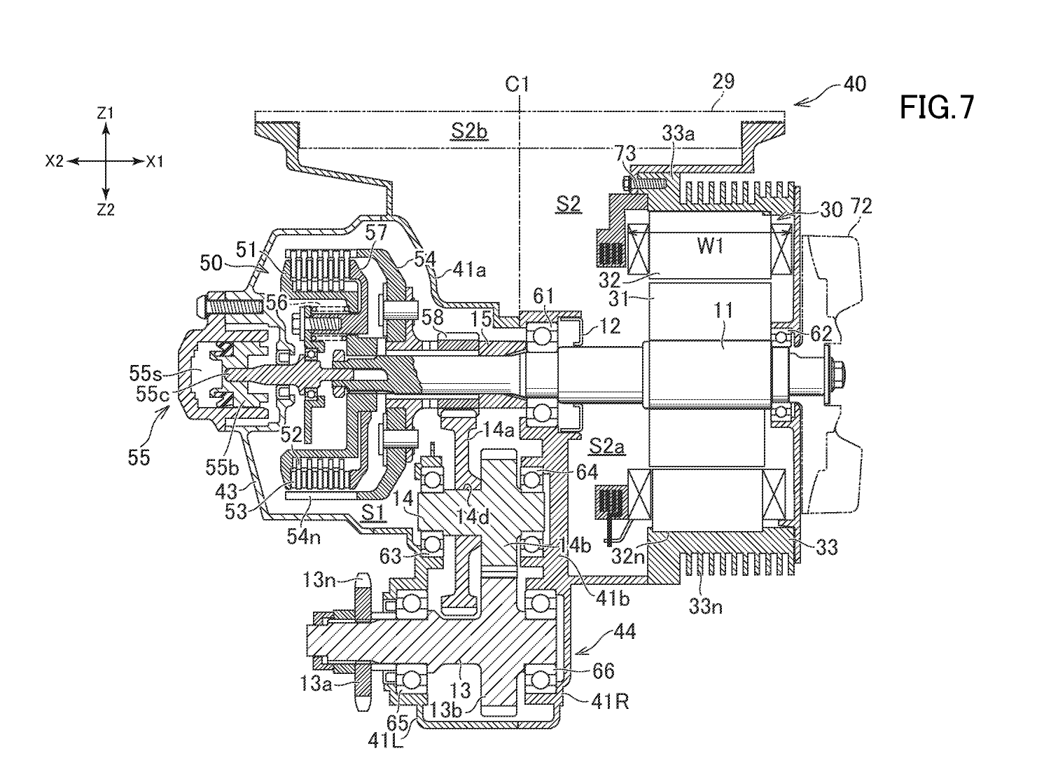

FIG. 1 is a side view of an electric motorcycle 1. FIGS. 2 and 3 show a battery case 20 and a driving unit case 40 provided on the electric motorcycle 1. FIG. 2 is a side view, and FIG. 3 is a front view. In the description below, the arrows Y1 and Y2 indicate the forward and rearward directions, respectively, of the vehicle, X1 and X2 are the rightward and leftward directions, respectively, of the vehicle, and Z1 and Z2 are the upward and downward directions, respectively, of the vehicle. The direction indicated by the arrows X1-X2 is referred to as the vehicle width direction or the shaft direction of the drive shaft 11 (see FIG. 7).

As shown in FIG. 1, the electric motorcycle 1 includes a front wheel 2 and a steering handle 3 that steers the front wheel 2. The steering handle 3 is connected to the front wheel 2 via a front fork 4. The electric motorcycle 1 includes a seat 5 which a driver straddles. The electric motorcycle 1 includes a rear wheel 6 and an electric motor 30 that drives the rear wheel 6. The rear wheel 6 is supported by rear arms 17 so as to move in the up-down direction. The electric motorcycle 1 includes a battery 7 that stores electric power to be supplied to the electric motor 30 and a battery case 20 that houses the battery 7. The battery case 20 preferably includes, in the upper portion thereof, a cover 21 that is able to be opened and closed (see FIG. 2). The battery 7 is able to be taken out of the battery case 20 when the cover 21 is opened.

According to a preferred embodiment of the electric motorcycle 1, the battery case 20 is disposed below the seat 5, and the electric motor 30 is disposed below the battery case 20. The electric motor 30 is disposed in the driving unit case 40. As is to be described below, a clutch 50 is disposed in the driving unit case 40 (see FIG. 7). A clutch lever 3a for a driver to operate the state of engagement of the clutch 50 is provided on the steering handle 3 (the clutch lever 3a corresponds to a “clutch operator”.

As shown in FIG. 2, a low voltage battery 9 that supplies electric power to a light, and a controller (not shown) that controls the electric motor 30 or the like are preferably disposed inside the battery case 20. The low voltage battery 9 outputs a voltage lower than the voltage outputted by the battery 7. Layout of the low voltage battery 9 is not limited to that described above. For example, the low voltage battery 9 may be disposed in a position spaced away from the battery case 20 at the rear of the vehicle body.

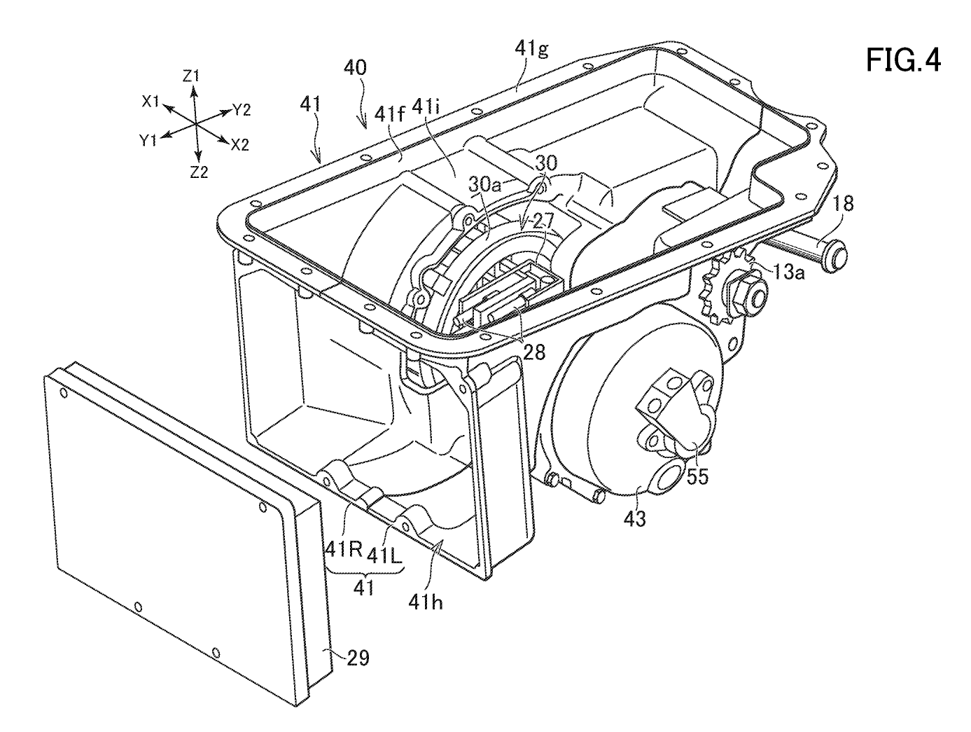

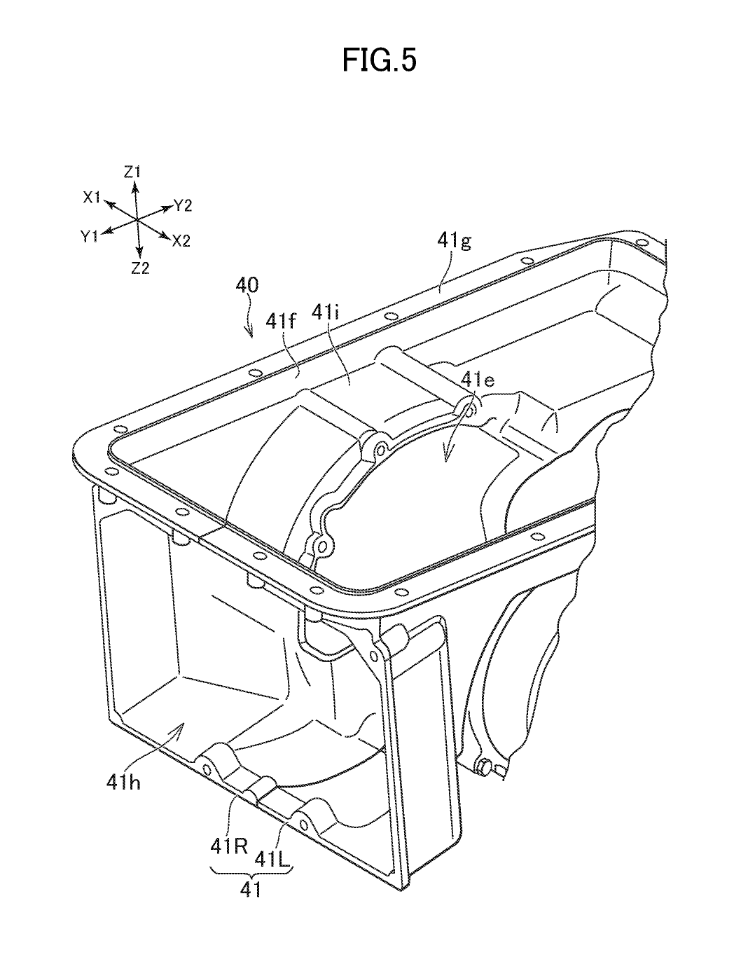

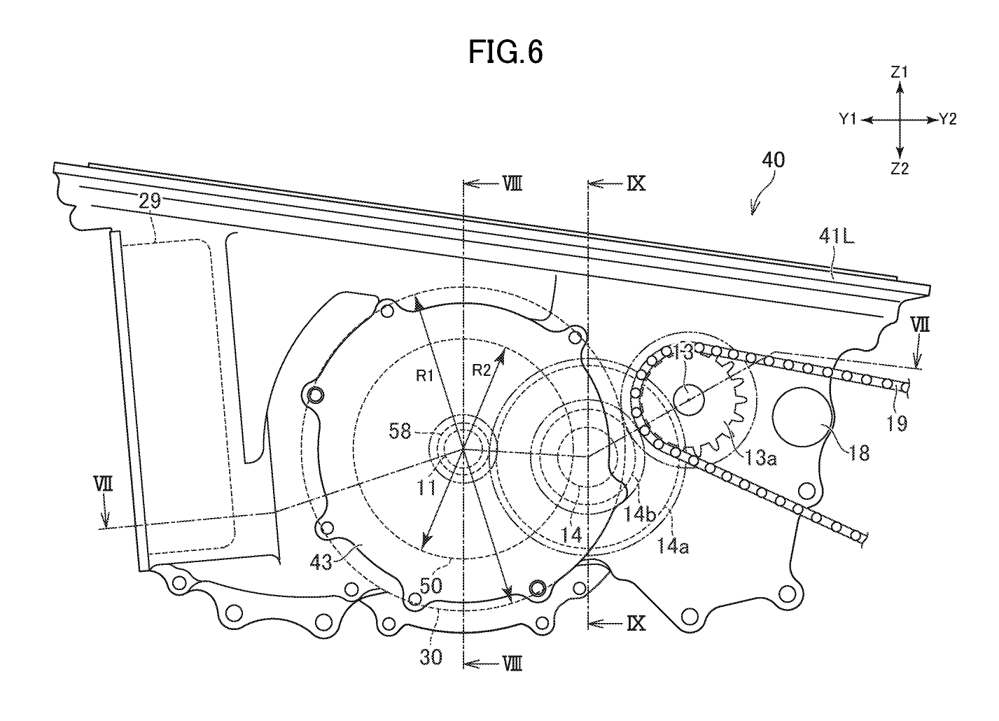

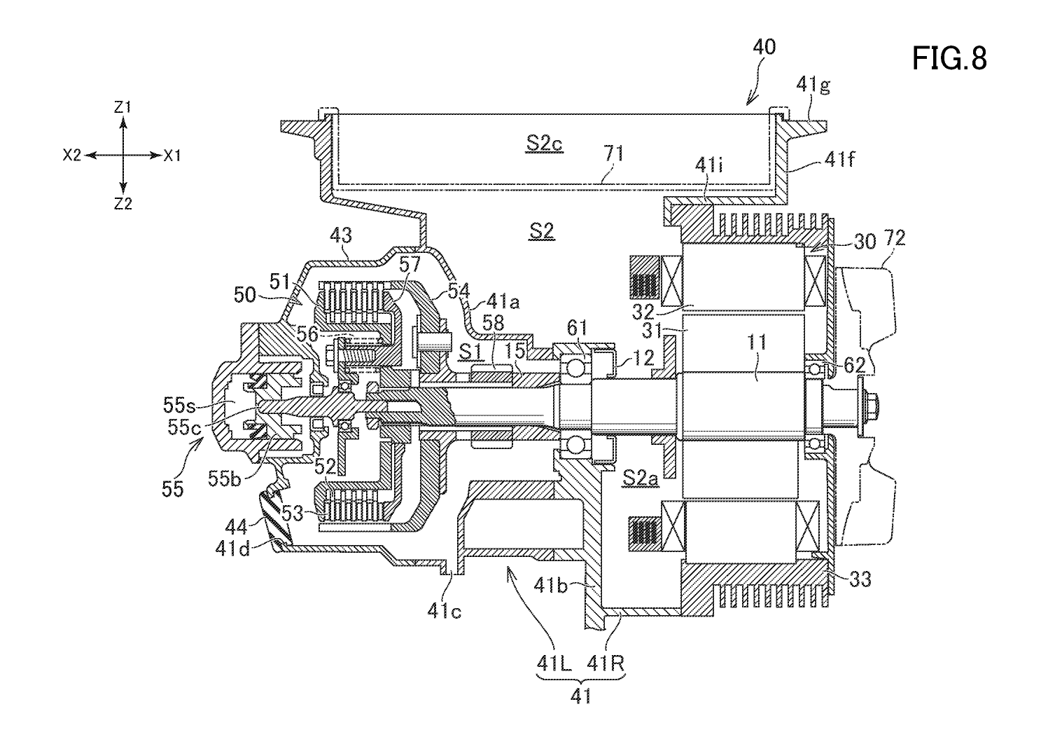

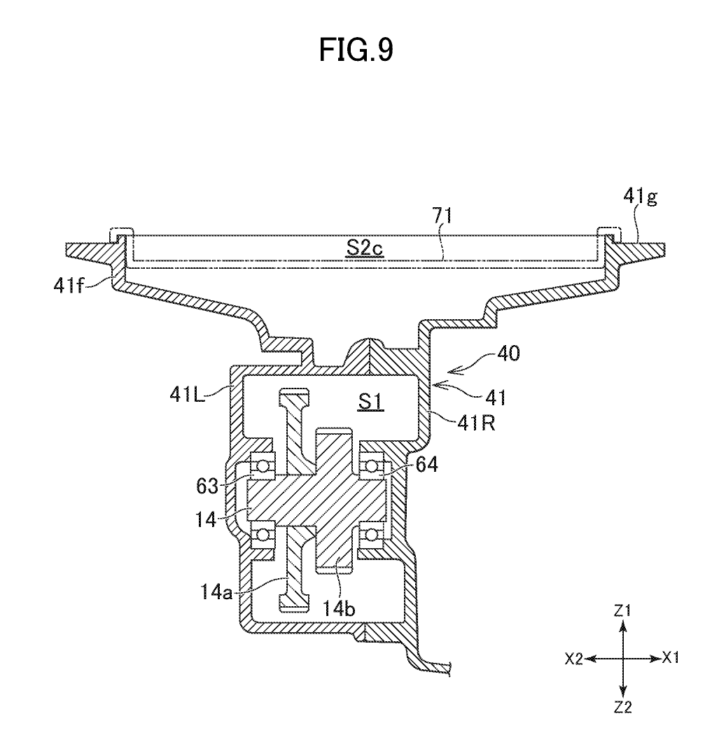

FIGS. 4 and 5 are perspective views of the driving unit case 40. In FIG. 5, the electric motor 30 is removed from the driving unit case 40. FIG. 6 is a side view of the driving unit case 40. In FIG. 6, the driving unit housed in the driving unit case 40 is shown by a broken line, and a hydraulic unit 55 to be described below is omitted (the “driving unit” preferably includes the electric motor 30, the clutch 50, an intermediate shaft, and an output shaft to be described below). FIGS. 7, 8, and 9 are cross sectional views of the driving unit case 40. FIG. 7 is a cross sectional view along the line VII-VII in FIG. 6. FIG. 8 is a cross sectional view along the line VIII-VIII in FIG. 6. FIG. 9 is a cross sectional view along the line IX-IX in FIG. 6.

As shown in FIG. 7, the drive shaft 11, the electric motor 30, and the clutch 50 are disposed in the driving unit case 40.

As shown in FIG. 7, the electric motor 30 is mounted on the drive shaft 11. The electric motor 30 receives electric power from the battery 7, and generates a torque that rotates the drive shaft 11. The electric motor 30 includes a rotor 31 that rotates integrally with the drive shaft 11 and a stator 32 fixed to the vehicle body that receives electric power from the battery 7 and causes the rotor 31 to rotate. According to a preferred embodiment of the electric motor 30, the stator 32 is fixed to a motor housing 33 to be described below that defines a portion of the driving unit case 40. The electric motor 30 is, for example, a radial gap motor. That is, the stator 32 is positioned outside relative to the rotor 31 in the radial direction of the drive shaft 11 and surrounds the outside of the rotor 31. The electric motor 30 may be, for example, an axial gap motor in which a stator is positioned opposed to a rotor in the shaft direction of the drive shaft 11. As shown in FIG. 7, a fan 72 that cools the electric motor 30 is preferably mounted on an end portion of the drive shaft 11. The fan 72 is positioned outside of the electric motor 30 in the vehicle width direction. The fan 72 rotates integrally with the drive shaft 11 to send outside air to the electric motor 30 (in detail, send outside air to the lateral surface of the motor housing 33).

As shown in FIG. 7, the clutch 50 is mounted on the drive shaft 11, similar to the electric motor 30. The clutch 50 includes a driving member that rotates integrally with the drive shaft 11 and a driven member that rotates relative to the driving member and the drive shaft 11 and receives a torque (rotation) from the driving member through engagement with the driving member.

The clutch 50 is, for example, a multiple disk clutch. That is, the driven member of the clutch 50 includes a plurality of first clutch plates 53 and a clutch housing 54 that rotates integrally with the plurality of first clutch plates 53. The first clutch plates 53 and the clutch housing 54 rotate integrally with a first gear 58 on the drive shaft 11. The driving member of the clutch 50 includes a plurality of second clutch plates 52 and a clutch inner 51 that are disposed inside the clutch housing 54 and rotate integrally with the drive shaft 11. The plurality of first clutch plates 53 and the plurality of second clutch plates 52 are alternately disposed in the shaft direction of the drive shaft 11. The clutch 50 includes a pressure plate 57 that is able to move in the shaft direction of the drive shaft 11 in response to an operation of the clutch lever 3a and presses the first clutch plate 53 and the second clutch plates 52 toward each other. In an example of the clutch 50, the pressure plate 57 presses the first clutch plate 53 and the second clutch plates 52 toward each other by utilizing an elastic force of a clutch spring 56.

As described above, the first gear 58 that rotates relative to the drive shaft 11 is mounted on the drive shaft 11. The first gear 58 receives a torque (rotation) of the electric motor 30 via the clutch 50. That is, the first gear 58 rotates integrally with the driven member (more specifically, the clutch housing 54) of the clutch 50. As shown in FIG. 7, an output shaft 13 that receives a torque of the electric motor 30 via the first gear 58 is additionally provided in the driving unit case 40. According to a preferred embodiment of the electric motorcycle 1, the torque of the electric motor 30 is transmitted to the output shaft 13 via an intermediate shaft 14. A sprocket 13a is mounted on the output shaft 13 (the sprocket 13a corresponds to an “output member”. The sprocket 13a is linked to the driving wheel of the electric motorcycle 1, that is, linked to the rear wheel 6, via a chain 19 (see FIG. 6), and the rotation of the sprocket 13a (a torque from the electric motor 30) is transmitted to the rear wheel 6 via the chain 19. Note that a pulley may be provided as the “output member” instead of the sprocket 13a on the output shaft 13. Then, a belt may be used instead of the chain 19 as a torque transmission to transmit the torque (rotation) to the rear wheel 6. A bevel gear may be provided as the “output member” on the output shaft 13, instead of the sprocket 13a, and a shaft may be used as the torque transmission instead of the chain 19.

As shown in FIG. 7, the electric motor 30 is disposed rightward from the middle C1 in the vehicle width direction. Meanwhile, the clutch 50 and the sprocket 13a are disposed leftward from the middle C1 in the vehicle width direction. With this layout, even when an electric motor 30 having a large diameter is used, the electric motor 30 does not interfere with the sprocket 13a. Therefore, it is possible to increase the output torque of the electric motor 30 without increasing the width of the electric motor 30 in the shaft direction of the drive shaft 11. According to a preferred embodiment of the electric motorcycle 1, the electric motor 30 has a diameter R1 (see FIG. 6) that is larger than the width W1 (see FIG. 7) in the shaft direction of the drive shaft 11, that is, in the vehicle width direction. As described above, the electric motor 30 and the clutch 50 are both mounted on the drive shaft 11. With the above configuration, a smaller torque is inputted to the clutch 50, compared to a structure in which, for example, a torque of an electric motor is inputted to a clutch via a speed reduction mechanism. As a result, it is possible to reduce the size of the clutch 50. Therefore, it is possible to shorten the distance between the drive shaft 11 and the output shaft 13, and thus able to reduce the size of the driving unit case 40.

According to a preferred embodiment of the electric motorcycle 1, as shown in FIG. 6, the diameter R1 of the electric motor 30 is larger than the diameter R2 of the clutch 50 (note here that the diameter R1 of the electric motor 30 is the outside diameter of the stator 32, and the diameter R2 of the clutch 50 is the outside diameter of the clutch housing 54). As a result, the outside diameter of the motor housing 33 as well is larger than the outside diameter of a clutch cover 43 disposed outward from the clutch 50 in the vehicle width direction and covering the clutch 50. As shown in FIGS. 6 and 7, the sprocket 13a is positioned behind the clutch 50 and the clutch cover 43 in a side view and a cross section.

The clutch 50 is connected to the clutch lever 3a so that the state of engagement of the clutch 50 is changed in response to an operation of the clutch lever 3a. That is, it is possible to change the state of engagement of the driving member and the driven member of the clutch 50 through operation of the clutch lever 3a by the driver. With the above configuration, it is possible to increase the degree of freedom in torque transmission control by the driver, compared to a centrifugal clutch in which the state of engagement is automatically changed depending on the rotation speed of the electric motor. For example, a driver is able to instantly disconnect torque transmission to the rear wheel 6 by operating the clutch lever 3a. Moreover, it is possible to instantly obtain a large driving torque by rapidly engaging the clutch 50 while the electric motor 30 is outputting a large torque.

According to a preferred embodiment of the electric motorcycle 1, the clutch lever 3a is mechanically connected to the clutch 50. More specifically, the clutch lever 3a is connected to the hydraulic unit 55 of the clutch 50 (see FIGS. 4 and 7) via a hydraulic hose (not shown). As shown in FIG. 7, the hydraulic unit 55 includes, inside thereof, a cylinder 55s that receives oil through a hydraulic hose. The cylinder 55s includes a piston 55b that is movable in the shaft direction of the drive shaft 11. The clutch 50 includes a rod 55c that is movable in the shaft direction of the drive shaft 11 together with the piston 55b. The rod 55c is movable in the shaft direction of the drive shaft 11 together with the pressure plate 57. When the pressure inside the cylinder 55s increases as the clutch lever 3a is operated, the rod 55c presses the pressure plate 57 in a direction that causes the clutch inner 51 and the pressure plate 57 to separate from each other. The pressure plate 57 is pressed by the clutch spring 56 in a direction that causes the pressure plate 57 to approach the clutch inner 51.

The clutch lever 3a may be connected to the clutch 50 via a wire, instead of by the hydraulic hose. Alternatively, the clutch lever 3a may be electrically connected to the clutch 50. For example, an actuator that moves the pressure plate 57 may be provided on the clutch 50, and the actuator may be electrically connected to the clutch lever 3a via a harness or a controller. Then, the state of engagement of the clutch 50 may be operated through operation of the actuator.

The first gear 58 on the drive shaft 11 is positioned between the electric motor 30 and the clutch 50 in the vehicle width direction. As shown in FIG. 7, the intermediate shaft 14 that defines a speed reduction mechanism is disposed between the drive shaft 11 and the output shaft 13 on the torque transmission path. That is, rotation (torque) of the electric motor 30 is transmitted to the output shaft 13 via the intermediate shaft 14.

As shown in FIG. 6, according to a preferred embodiment of the electric motorcycle 1, the drive shaft 11 and the intermediate shaft 14 are located at a position lower than the output shaft 13 in a side view of the driving unit case 40. With the above configuration, it is possible to achieve a low barycenter of the vehicle body. Further, with the above structure, the distance between the drive shaft 11 and the output shaft 13 in the front-back direction is shortened, and thus it is possible to reduce the size of the driving unit case 40. In a side view of the driving unit case 40, the intermediate shaft 14 is positioned farther rearward than the drive shaft 11 and farther frontward than the output shaft 13. The positional relationship between the drive shaft 11, the intermediate shaft 14, and the output shaft 13 is not limited to the example shown in FIG. 6, and may be desirably changed.

A pivot shaft 18 supporting the front end portion of the rear arm 17 is located behind the output shaft 13 (see FIG. 4). The pivot shaft 18 is supported by a case main body 41 to be described below that defines the driving unit case 40.

As shown in FIG. 7, a second gear 14a that rotates integrally with the first gear 58 and a third gear 14b, a diameter of which is smaller than a diameter of the second gear 14a, are mounted on the intermediate shaft 14. The third gear 14b rotates integrally with a gear 13b on the output shaft 13 (the gear 13b on the output shaft 13 will be hereinafter referred to as a fourth gear). According to a preferred embodiment of the electric motorcycle 1, the second gear 14a is engaged with the first gear 58, and the third gear 14b is engaged with the fourth gear 13b on the output shaft 13. Instead of these, the second gear 14a on the intermediate shaft 14 may be indirectly engaged with the first gear 58 on the drive shaft 11 (that is, the rotation of the first gear 58 may be transmitted to the second gear 14a via another shaft and another gear). The third gear 14b on the intermediate shaft 14 may be indirectly engaged with the fourth gear 13b on the output shaft 13. Rotation of the drive shaft 11 is decelerated by the gears 58, 14a, 14b, 13b before being transmitted to the output shaft 13.

As shown in FIG. 7, the intermediate shaft 14 is supported by two bearings 63, 64. The bearings 63, 64 are positioned between the clutch 50 and the electric motor 30 in the vehicle width direction. That is, the bearings 63, 64 are positioned closer to the electric motor 30 than the end portion of the clutch 50 that is closer to the middle C1 in the vehicle width direction. Further, the bearings 63, 64 are positioned closer to the clutch 50 than the end portion of the electric motor 30 that is closer to the middle C1 in the vehicle width direction. In other words, the entire intermediate shaft 14 is positioned closer to the electric motor 30 than the end portion of the clutch 50 that is closer to the middle C1 in the vehicle width direction, and closer to the clutch 50 than the end portion of the electric motor 30 that is closer to the middle C1 in the vehicle width direction. With the above configuration, it is possible to shorten the distance between the drive shaft 11 and the intermediate shaft 14, and reduce the size of the driving unit case 40 as a result.

According to a preferred embodiment of the electric motorcycle 1, as shown in FIG. 7, a portion of each bearing 63, 64 (a front portion of each bearing 63, 64) is positioned more forward than the rear end of the clutch 50, that is, positioned more forward than the rear end 54n of the clutch housing 54 in the example of the electric motorcycle 1. Thus, a portion of each bearing 63, 64 overlaps with the clutch 50 in a side view of the driving unit case 40. With the above configuration, the distance between the intermediate shaft 14 and the drive shaft 11 is shorter, which makes it possible to reduce the size of the driving unit. As shown in FIG. 7, a portion (the front surface 14d) of the intermediate shaft 14 as well may be positioned more forward than the rear end 54n of the clutch 50. Further, instead of the example shown in FIG. 7, each bearing 63, 64 may be arranged so as to entirely overlap with the clutch 50 in a side view of the driving unit case 40.

As shown in FIG. 7, each bearing 63, 64 is positioned more forward than the rear end of the electric motor 30, that is, the rear end 32n of the stator 32. Thus, each bearing 63, 64 overlaps with the electric motor 30 in a side view of the driving unit case 40. According to a preferred embodiment of the electric motorcycle 1, each bearing 63, 64 entirely overlaps with the electric motor 30 in a side view of the driving unit case 40. Alternatively, each bearing 63, 64 may only partially (the front portion) overlap with the electric motor 30 in a side view of the driving unit case 40.

The distance between the intermediate shaft 14 and the drive shaft 11 is shorter, as described above, and it is possible to shorten the distance between the drive shaft 11 and the output shaft 13 as a result. Thus, according to a preferred embodiment of the electric motorcycle 1, a portion (the front end portion 13n) of the sprocket 13a is positioned more forward than the rear end 33n of the motor housing 33, as shown in FIG. 7. As a result, the sprocket 13a partially overlaps with the motor housing 33 in a side view of the vehicle body. Arrangement of the sprocket 13a is not necessarily limited to the example of the electric motorcycle 1, and the sprocket 13a may be positioned more rearward than the rear end 33n of the motor housing 33, for example.

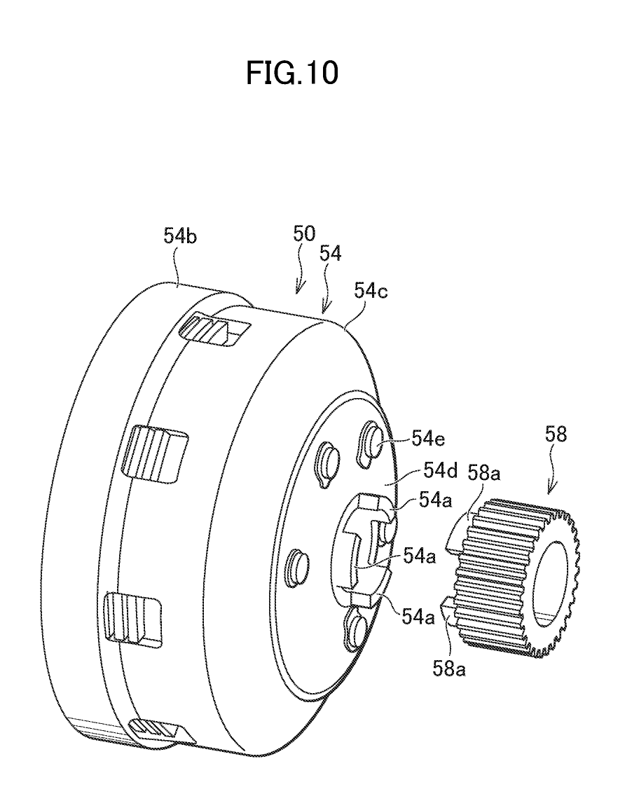

The first gear 58 on the drive shaft 11 has a diameter smaller than a diameter of the clutch 50 (more specifically, the clutch housing 54). According to a preferred embodiment of the electric motorcycle 1, the first gear 58 is engaged with the clutch 50 via engagement projections 58a, 54a (see FIG. 10) that project in the shaft direction of the drive shaft 11, as is to be described below. In detail, the first gear 58 is engaged with the side portion 54d of the clutch housing 54 via the engagement projections 58a, 54a (see FIG. 10). With the above configuration, it is possible to decrease the diameter of the first gear 58, compared to a structure in which, for example, the first gear 58 is engaged with the clutch housing 54 via a spline or a projection that project in the diameter direction of the drive shaft 11. Accordingly, it is possible to ensure a sufficient reduction ratio, while shortening the distance between the drive shaft 11 and the intermediate shaft 14. Further, use of the engagement projections 58a, 54a that project in the shaft direction of the drive shaft 11 makes it easier to ensure a space in the shaft direction between the clutch housing 54 and the first gear 58. Then, using the space, it is possible to arrange the bearing 63 to support the intermediate shaft 14.

As shown in FIG. 7, the bearings 63, 64 that support the intermediate shaft 14 are located at both respective ends of the intermediate shaft 14. The output shaft 13 is supported by bearings 65, 66. One bearing 66 is located at an end of the output shaft 13, while the other bearing 65 is located between the sprocket 13a and the fourth gear 13b.

The drive shaft 11 is supported by the bearings 61, 62. According to a preferred embodiment of the electric motorcycle 1, the bearing 61 is positioned between the clutch 50 and the electric motor 30. In detail, the bearing 61 is positioned between the first gear 58 and the electric motor 30. A spacer 15 is disposed between the bearing 61 and the first gear 58. The other bearing 62 is positioned outward from the electric motor 30 in the vehicle width direction (in the shaft direction of the drive shaft 11). The drive shaft 11 is supported only by two bearings 61, 62. According to a preferred embodiment of the electric motorcycle 1, the clutch housing 54 and the first gear 58 are preferably made of different materials, as is to be described below. With the above configuration, it is possible to make the clutch housing 54, using a material that is lighter (for example, aluminum) than that of the first gear 58, which makes it possible to reduce the weight of the clutch 50. This makes it easier to reduce the number of bearings that support the drive shaft 11. The number of bearings that support the drive shaft 11 is not limited to two, and a larger number of bearing may be used to support the drive shaft 11. For example, a bearing that supports the drive shaft 11 may be provided on the side of the clutch 50.

As shown in FIG. 4, the driving unit case 40 includes the case main body 41. The case main body 41 includes a right half case section 41R that defines the right half thereof and a left half case section 41L that defines the left half thereof. The right half case section 41R and the left half case section 41L are fixed to each other in the vehicle width direction. In this preferred embodiment, the driving unit case 40 includes the case main body 41, the motor housing 33, and the clutch cover 43, and houses the above described electric motor 30, clutch 50, drive shaft 11, intermediate shaft 14, and output shaft 13.

As shown in FIG. 7, according to a preferred embodiment of the electric motorcycle 1, the bearings 61, 64, 66 are supported by the right half case section 41R, that is, the half case section on the side of the electric motor 30. The bearings 63, 65 are supported by the left half case section 41L, that is, the half case section on the side of the clutch 50.

The second gear 14a and the third gear 14b are disposed between the two bearings 63, 64 that support the intermediate shaft 14. Since this ensures a sufficient distance between the two bearings 63, 64 in the vehicle width direction, the two bearings 63, 64 are provided to two half case sections 41R, 41L, respectively, that are combined to each other in the vehicle width direction.

As shown in FIG. 7, each of the gears 58, 14a, 14b, 13b that define the speed reduction mechanism is positioned farther rightward than the bearing 63 on the left side that supports the intermediate shaft 14. This makes it easier to support the bearing 63 by the left half case section 41L without using a dedicated member to support the bearing 63.

As shown in FIG. 7, the second gear 14a on the intermediate shaft 14 is positioned closer to the clutch 50 from the third gear 14b on the intermediate shaft 14. With the above configuration, it is possible to prevent the distance between the first gear 58 engaging with the second gear 14a and the clutch 50 in the shaft direction of the drive shaft 11 from becoming excessively long.

As shown in FIG. 7, the rear portion of the second gear 14a on the intermediate shaft 14 is positioned between the bearing 65 that supports the output shaft 13 and the fourth gear 13b on the output shaft 13. With the above configuration, it is possible to prevent the distance between the output shaft 13 and the intermediate shaft 14 from becoming long, and also to ensure a sufficiently long distance between the two bearings 65, 66 that support the output shaft 13. This ensures a sufficient strength to support the output shaft 13. The arrangement of the gears 14a, 14b on the intermediate shaft 14 is not limited to the example shown in FIG. 7. For example, the second gear 14a engaged with the first gear 58 on the drive shaft 11 may be disposed in a position closer to the electric motor 30 relative to the third gear 14b.

As shown in FIG. 4, the electric motorcycle 1 includes a motor driver 29. The motor driver 29 supplies electric power received from the battery 7 to the electric motor 30. In detail, the motor driver 29 includes an inverter, and converts an electric power received from the battery 7 from DC to AC before supplying it to the electric motor 30. According to a preferred embodiment of the electric motorcycle 1, the motor driver 29 is disposed forward of the electric motor 30 and the clutch 50. With the above configuration, it is easier to cool the motor driver 29 while the vehicle is running. Layout of the motor driver 29 is not limited to that described above. For example, the motor driver 29 may be disposed above the electric motor 30 and the clutch 50 and below the battery 7. Further, the motor driver 29 may be disposed behind the battery 7 or below the seat 5.

According to a preferred embodiment of the electric motorcycle 1, the motor driver 29, in addition to the above described electric motor 30, clutch 50, drive shaft 11, intermediate shaft 14, and output shaft 13, is disposed in the driving unit case 40. With the above configuration, it is possible to shorten a wiring 28 that connects the motor driver 29 and the electric motor 30 (see FIG. 4). As shown in FIG. 7, the driving unit case 40 includes a first housing space S1 and a second housing space S2. The torque transmission mechanism that includes the clutch 50, the intermediate shaft 14, the output shaft 13, or the like is disposed in the first housing space S1. The electric motor 30 and the motor driver 29 are disposed in the second housing space S2. The drive shaft 11 extends over the first housing space S1 and the second housing space S2. The first housing space S1 includes the case main body 41 and the clutch cover 43, and the second housing space S2 includes the case main body 41 and the motor housing 33.

The motor driver 29 is disposed forward of the electric motor 30 and the clutch 50. The case main body 41 includes an opening 41h that opens forward (see FIG. 4). The opening 41h is preferably rectangular, for example, as shown in FIG. 4. The motor driver 29 is inserted into the opening 41h, and fixed to the edge of the opening 41h. The front surface of the motor driver 29 is exposed forward from the driving unit case 40. With the above configuration, it is possible to effectively cool the motor driver 29 when wind hits the front surface of the motor driver 29 while the vehicle is moving. A structure for mounting the motor driver 29 is not limited to that described above. For example, the entire motor driver 29 may be housed in the case main body 41.

As shown in FIGS. 7 and 8, the case main body 41 includes wall portions 41a, 41b that define the first housing space S1 and the second housing space S2. Each wall portion 41a, 41b includes no hole and no opening that penetrates the two housing spaces S1, S2 except a hole which the drive shaft 11 penetrates. With the above configuration, while oil is supplied to the mechanism and bearings disposed in the first housing space S1, it is possible to prevent the oil from touching the electric motor 30 and the motor driver 29 disposed in the second housing space S2. A seal member 12 is provided in the hole where the drive shaft 11 passes through. As shown in FIG. 8, a drain 41c to discharge oil and an opening 41d via which an operator checks the oil by viewing may be provided in the first housing space S1. The opening 41d may be closed by a cap 44.

As shown in FIG. 7, the second housing space S2 includes a motor housing space S2a where the electric motor 30 is disposed and a driver housing space S2b where the motor driver 29 is disposed. The motor housing space S2a is defined by the motor housing 33, and the driver housing space S2b is defined by the case main body 41.

As shown in FIG. 5, the driving unit case 40 includes an opening 41e for communication between the motor housing space S2a and the driver housing space S2b. The opening 41e is provided on the case main body 41. According to a preferred embodiment of the electric motorcycle 1, the opening 41e is provided on the right half case section 41R. A portion of the electric motor 30 is exposed toward the driver housing space S2b through the opening 41e. According to a preferred embodiment of the electric motorcycle 1, a portion of the electric motor 30 closer to the middle C1 in the vehicle width direction, more specifically, the upper portion 30a of the electric motor 30 (see FIG. 4) is exposed toward the driver housing space S2b. By use of the opening 41e, the electric motor 30 and the motor driver 29 are electrically connected to each other. As shown in FIG. 4, a terminal pedestal 27 is disposed inward from the electric motor 30 in the vehicle width direction, that is, disposed between the electric motor 30 and the clutch 50. A terminal of the wiring 28 is fixed on the terminal pedestal 27 (the terminal pedestal 27 is not shown in FIGS. 7 and 8). The position of the opening 41e is not limited to the example shown in FIG. 5. For example, the opening may be provided on a wall portion 41i that covers the upper side of the electric motor 30 (see FIG. 4). By use of the opening, the electric motor 30 and the motor driver 29 are electrically connected to each other.

As described above, the stator 32 is fixed inside the motor housing 33. As shown in FIG. 7, the motor housing 33 is positioned outward from the case main body 41 in the vehicle width direction. According to a preferred embodiment of the electric motorcycle 1, the motor housing 33 is positioned rightward from the case main body 41. The motor housing 33 is fixed to the case main body 41. In detail, the motor housing 33 is open toward the middle C1 in the vehicle width direction (according to a preferred embodiment of the electric motorcycle 1, the motor housing 33 opens leftward). The edge 33a of the opening of the motor housing 33 is in contact with the case main body 41 and is directly fixed to the case main body 41 (according to a preferred embodiment of the electric motorcycle 1, and the edge 33a of the opening of the motor housing 33 is directly fixed to the right half case section 41R). When the motor housing 33 is fixed to the case main body 41 as described above, it is possible to reduce the width of the driving unit case 40 in the vehicle width direction, compared to a structure in which another member is disposed between the edge 33a of the motor housing 33 and the case main body 41. According to a preferred embodiment of the electric motorcycle 1, the motor housing 33 is fixed to the right half case section 41R by a plurality of bolts 73, for example, disposed around the drive shaft 11.

A bolt 73, for example, is inserted into fixing holes in the motor housing 33 and the right half case section 41R from the inside of the case main body 41. In this structure, it is easier to use an electric motor 30 having a larger diameter, compared to a structure in which, for example, the bolt 73 is inserted into a mounting hole from the outside of the case main body 41. A structure that fixes the motor housing 33 is not limited to the example shown in FIG. 7. For example, the bolt 73 may be inserted into the fixing hole of the motor housing 33 from the outside of the case main body 41.

As shown in FIG. 8, the second housing space S2 of the driving unit case 40 further includes a housing space S2c that is positioned above the electric motor 30 and the clutch 50. Various electric equipment, for example, are disposed in the housing space S2c (the housing space S2c will be hereinafter referred to as an “electric equipment housing space”). The electric equipment includes a converter that lowers the voltage of the electric power of the battery 7 before supplying it to the battery 9, a relay that controls power supply from the battery 7, or the like. The electric equipment housing space S2c includes the case main body 41. That is, the case main body 41 includes a circumferential wall portion 41f that defines the electric equipment housing space S2c. The electric equipment housing space S2c may be provided above the intermediate shaft 14 and the output shaft 13 (see FIG. 9). Preferably, the width of the electric equipment housing space S2c is larger than a width of the portion of the case main body 41 where the intermediate shaft 14 and the output shaft 13 are disposed. A tray 71 supporting the electric equipment may be disposed inside the electric equipment housing space S2c. A component that is disposed in the housing space S2c is not limited to electric equipment. The upper edge 41g of the circumferential wall portion 41f (see FIG. 4) is fixed to the battery case 20.

As shown in FIG. 3, the motor driver 29 overlaps with a portion (a portion toward the middle C1 in the vehicle width direction) of the electric motor 30 and a portion of the clutch 50 (a portion toward the middle C1 in the vehicle width direction) in a front view of the vehicle body. With the above configuration, it is possible to shorten the distance between the electric motor 30 and the motor driver 29, and thus shorten the wiring 28 connecting these components. Further, as the motor driver 29 receives more wind when the vehicle is moving, it is possible to effectively cool the motor driver 29. The motor driver 29 may overlap with the entire electric motor 30 in a front view of the vehicle body. Further, the motor driver 29 may overlap with the entire clutch 50 in a front view of the vehicle body.

The electric motor 30, clutch 50, drive shaft 11, intermediate shaft 14, output shaft 13, and motor driver 29 are disposed below the battery case 20. That is, the driving unit case 40 is disposed below the battery case 20. As shown in FIG. 2, the motor driver 29 is positioned farther rearward than the front end 20a of the battery case 20. With the above, water, sand, pebbles or the like that are splashed by the front wheel 2 while a vehicle is moving are readily prevented from hitting the motor driver 29.

As shown in FIG. 3, the position of the lower edge 29a of the motor driver 29 is higher than the position of the lower edge 40c of the portion of the driving unit case 40 in which the electric motor 30 and the clutch 50 are housed in a front view of the vehicle body. With the above configuration, water, sand, pebbles or the like splashed by the front wheel 2 when a vehicle is moving are more effectively prevented from hitting the motor driver 29.

As shown in FIG. 2, the output shaft 13 is positioned farther forward than the rear end 20b of the battery case 20. With the above configuration, it is possible to reduce the size of the driving unit case 40, and to make it easier to set an appropriate wheel base, that is, the distance between the front wheel 2 and the rear wheel 6.

As described above, the battery case 20 is disposed below the seat 5. As shown in FIG. 3, the width W3 of the battery case 20 in the vehicle width direction is smaller than the width W2 of the driving unit case 40 in the vehicle width direction. With the above configuration, when a driver straddles the seat 5, the battery case 20 is easily positioned between his/her both legs. In this description, the width W3 of the battery case 20 refers to the width of the upper portion of the battery case 20. Further, the width W2 of the driving unit case 40 is the width of the portion of the driving unit case 40 in which the electric motor 30 and the clutch 50 are disposed. That is, the width W2 of the driving unit case 40 is the distance between the end portion 33d of the motor housing 33 in the vehicle width direction and the end portion 43d of the clutch cover 43 in the vehicle width direction.

As described above, the clutch 50 and the first gear 58 are disposed on the drive shaft 11. The first gear 58 and the clutch housing 54 are individual elements. The first gear 58, the clutch housing 54, and the first clutch plate 53 integrally rotate, and rotate relative to the drive shaft 11. FIG. 10 is a perspective view of the clutch 50 and the first gear 58. Engagement projections 58a, 54a that project in the shaft direction of the drive shaft 11 are provided on at least one of the first gear 58 and the clutch housing 54. The first gear 58 and the clutch housing 54 are engaged with each other through the engagement projections 58a, 54a so that the first gear 58 and the clutch housing 54 integrally rotate. With the above configuration, it is possible to decrease the diameter of the first gear 58, compared to a structure in which the first gear 58 and the clutch housing 54 are engaged with each other by using a spline or a projection projecting in the radial direction of the drive shaft 11. As a result, it is possible to readily obtain a sufficient reduction ratio while shortening the distance from the drive shaft 11 to the intermediate shaft 14 and the output shaft 13.

According to a preferred embodiment of the electric motorcycle 1, as shown in FIG. 10, the first gear 58 includes a plurality of engagement projections 58a that project towards the clutch 50 in the shaft direction. The plurality of engagement projections 58a surround the drive shaft 11 at intervals. The clutch housing 54 includes a plurality of engagement projections 54a projecting toward the first gear 58 in the shaft direction. The plurality of engagement projections 54a surround the drive shaft 11 at intervals, and are engaged with the respective engagement projections 58a of the first gear 58. That is, each engagement projection 54a is inserted between two adjacent engagement projections 58a.

The first gear 58 and the clutch housing 54 may be made of different materials. Thus, it is possible to reduce the weight of the clutch 50 while ensuring sufficient strength of the engagement structure for the first gear 58 and the clutch housing 54. According to a preferred embodiment of the electric motorcycle 1, the clutch housing 54 includes a main body 54c including a barrel portion 54b that surrounds the first clutch plate 53, and a side portion 54d fixed to the side surface (the surface on the side of the first gear 58) of the main body 54c by a fixture 54e such as a bolt, a rivet, or the like. The engagement projection 54a is provided on the side portion 54d. The main body 54c is preferably made of material (e.g., aluminum) that is lighter than the material (for example, iron) of the first gear 58. The side portion 54d may be made of the same material as that of the first gear 58.

As described above, in the electric motorcycle 1, the electric motor 30 is disposed rightward from the middle C1 in the vehicle width direction. Meanwhile, the clutch 50 and the sprocket 13a are disposed leftward from the middle C1 in the vehicle width direction. With this layout, interference is not caused between the electric motor 30 and the sprocket 13a even when an electric motor 30 having a large diameter is used. This makes it easier to increase an output torque of the electric motor 30. Further, the electric motor 30 and the clutch 50 are both disposed on the drive shaft 11. With the above configuration, a smaller torque is inputted to the clutch 50, compared to a structure in which, for example, a torque of an electric motor is inputted to a clutch via a speed reduction mechanism. As a result, it is possible to reduce the size of the clutch 50. Accordingly, it is possible to shorten the distance between the drive shaft 11 and the output shaft 13, and thus to reduce the size of the driving unit case 40. Further, the clutch 50 is connected to the clutch lever 3a so that the state of engagement of the clutch 50 is changed in response to an operation of the clutch lever 3a. With the above configuration, it is possible to increase the degree of freedom in torque transmission control by a driver.

Preferred embodiments of the present invention are not limited to the above described electric motorcycle 1 and may be modified in various manners.

For example, the electric motor 30 may be disposed leftward from the middle C1 in the vehicle width direction, and the clutch 50 and the sprocket 13a may be disposed rightward from the middle C1 in the vehicle width direction.

Although the case main body 41 that defines the driving unit case 40 includes two members, that is, the right half case section 41R and the left half case section 41L, the case main body 41 may additionally include a member that supports a bearing, for example, in addition to the half case sections 41R, 41L.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A straddle-type electric vehicle comprising:
a clutch operator that is operated by a driver;
a drive shaft;
an electric motor mounted on the drive shaft on a first side from a middle of the vehicle in a vehicle width direction;
a clutch mounted on the drive shaft on a second side, opposite to the first side, from the middle of the vehicle in the vehicle width direction, the clutch operator being connected to the clutch to change a state of engagement of the clutch through an operation of the clutch operator by the driver;
a first gear mounted on the drive shaft that receives a torque of the electric motor through the clutch;
an output shaft that receives the torque of the electric motor through the first gear on the drive shaft; and
an output member mounted on the output shaft on the second side from the middle of the vehicle in the vehicle width direction, and linked to a driving wheel of the vehicle through a torque transmission.

2. The straddle-type electric vehicle according to claim 1, further comprising a motor housing that houses the electric motor and a clutch cover that houses the clutch, wherein a diameter of the motor housing is larger than a diameter of the clutch cover.

3. The straddle-type electric vehicle according to claim 1, further comprising an intermediate shaft that defines a speed reduction mechanism, wherein the intermediate shaft is disposed between the drive shaft and the output shaft.

4. The straddle-type electric vehicle according to claim 3, wherein the intermediate shaft is supported by at least two bearings, and the at least two bearings are located between the electric motor and the clutch in the vehicle width direction.

5. The straddle-type electric vehicle according to claim 4, wherein at least a portion of the two bearings overlaps with both of the electric motor and the clutch in a side view of the vehicle.

6. The straddle-type electric vehicle according to claim 3, wherein the intermediate shaft includes a second gear that is directly or indirectly engaged with the first gear on the drive shaft, and a third gear that has a diameter smaller than a diameter of the second gear and is directly or indirectly engaged with a gear on the output shaft;
the intermediate shaft is supported by two bearings; and
the second gear and the third gear on the intermediate shaft are located between the two bearings.

7. The straddle-type electric vehicle according to claim 1, further comprising a motor housing that houses the electric motor, wherein at least a portion of the output member overlaps with the motor housing in a side view of the vehicle.

8. The straddle-type electric vehicle according to claim 1, further comprising a motor driver including an inverter and that supplies electric power to the electric motor, wherein the motor driver is disposed forward of the electric motor and the clutch, and overlaps with at least a portion of the electric motor and at least a portion of the clutch in a front view of the vehicle.

9. The straddle-type electric vehicle according to claim 8, further comprising:
a battery that stores electric power to be supplied to the electric motor; and
a battery case that houses the battery; wherein
the drive shaft, the electric motor, the clutch, the output shaft, and the motor driver are disposed below the battery case;
the motor driver is located farther rearward than a front end of the battery case; and
the output shaft is located farther forward than a rear end of the battery case.

10. The straddle-type electric vehicle according to claim 1, further comprising:
a battery that stores electric power to be supplied to the electric motor; and
a battery case that houses the battery; wherein
the drive shaft, the electric motor, the clutch, and the output shaft are disposed below the battery case;
the drive shaft, the electric motor, the clutch, and the output shaft are disposed in a driving unit case; and
a width of the battery case is smaller than a width of the driving unit case at a location of the drive shaft.

11. The straddle-type electric vehicle according to claim 1, further comprising a motor driver including an inverter and that supplies electric power to the electric motor; wherein
the drive shaft, the electric motor, the clutch, the output shaft, and the motor driver are disposed in a driving unit case;
the driving unit case includes a first housing space in which the clutch and the output shaft are disposed and a second housing space in which the electric motor and the motor driver are disposed; and
the first housing space and the second housing space are defined by a wall in the driving unit case.

12. The straddle-type electric vehicle according to claim 11, wherein the second housing space includes a motor housing space in which the electric motor is disposed and a driver housing space in which the motor driver is disposed; and
the driving unit case includes an opening on a portion thereof that communicates the driver housing space with the motor housing space.

13. The straddle-type electric vehicle according to claim 1, wherein the drive shaft, the electric motor, the clutch, and the output shaft are disposed in a driving unit case;
the driving unit case includes a case main body and a motor housing that includes a motor housing space to house the electric motor; and
the motor housing is fixed to the case main body.

14. The straddle-type electric vehicle according to claim 1, wherein the clutch includes:
a plurality of first clutch plates that rotate integrally with the drive shaft;
a plurality of second clutch plates that are alternately disposed with the plurality of first clutch plates and rotate integrally with the first gear on the drive shaft; and
a pressure plate that is movable in a shaft direction of the drive shaft in response to an operation of the clutch operator by the driver, and that presses the plurality of first clutch plates and the plurality of second clutch plates toward each other.

15. The straddle-type electric vehicle according to claim 1, wherein at least one of the first gear on the drive shaft and the clutch includes an engagement that projects in a shaft direction of the drive shaft and is engaged with the other of the first gear and the clutch.

16. The straddle-type electric vehicle according to claim 1, wherein the drive shaft includes a fan mounted thereon to cool the electric motor.
